(19) United States
(12) Patent Application Publication
(10) Pub. No.: US 2020/0094930 A1
(43) Pub. Date: Mar. 26, 2020

(54) DIVING BREATHING TUBE WITH SAFETY WARNING DEVICE

(71) Applicant: SHENZHEN ALLWELL SPORTS PRODUCTS MANUFACTURING CO.,LTD, Shenzhen (CN)

(72) Inventor: Guoping Chen, Shenzhen (CN)

(21) Appl. No.: 16/437,155

(22) Filed: Jun. 11, 2019

(30) Foreign Application Priority Data
Sep. 21, 2018 (CN) 201821552733.6

(51) Int. Cl. B63C 11/26; B63C 11/20; F21V 31/00; F21V 23/00; F21V 23/04; F21V 23/02

(52) U.S. Cl. CPC B63C 11/26; B63C 11/205; F21V 31/005; F21Y 2115/10; F21V 23/0407; F21V 23/02; F21V 23/003

(57) ABSTRACT

A diving breathing tube with a safety warning device includes a tube body. One end of the tube body is provided with a mouthpiece, and the other end is provided with a tube head. The tube head includes a cover body and a cylinder body. The inner portion of the tube head is provided with a light warning device. The cover body is made of an insulating material with light transmission capacity. A waterproof sealing structure is adopted respectively between the cover body and the cylinder body of the tube head and between the tube head and the tube body. In the present invention, since the inner portion of the tube head of the diving breathing tube is provided with a light warning device, the light warning device has a slow flashing warning function, and can give out an SOS international standard rescue signal when a danger is encountered.

### CROSS-REFERENCE TO RELATED PATENT APPLICATION

This non-provisional application claims priority to and the benefit of, pursuant to 35 U.S.C. § 119(a), patent application Serial No. CN201821552733.6 filed in China on Sep. 21, 2018. The disclosure of the above application is incorporated herein in its entirety by reference.

### FIELD

The present invention relates to the technical field of diving appliances, in particular to a diving breathing tube with a safety warning device.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

At present, the common diving breathing tubes in the market mainly consist of three parts, i.e., a tube body, a tube head and a mouthpiece, wherein a waterproof structure is provided therebetween. Chinese patent CN201520471551.6 has disclosed a “Breathing Tube for Diving”. The function of the breathing tube for diving is limited to breathing, and it has no safety warning function and will bring some potential safety hazards to athletes. How to ensure the personal safety of athletes is very important for the rising water activities and complex sea environment. Therefore, a diving breathing tube with a safety warning function is urgently needed in order to further guarantee the personal safety of athletes.

### SUMMARY

In order to solve the problems in the prior art, the present invention provides a diving breathing tube with a safety warning device.

In order to realize the above purpose, the present invention provides a diving breathing tube with a safety warning device, comprising a tube body, one end of the tube body being provided with a mouthpiece, the other end being provided with a tube head, the tube head comprising a cover body and a cylinder body, wherein the inner portion of the tube head is provided with a light warning device, the cover body is made of an insulating material with light transmission capacity, and a waterproof sealing structure is adopted respectively between the cover body and the cylinder body of the tube head and between the tube head and the tube body.

The light warning device comprises a circuit board, and an indicator lamp, an MCU, a power source, two contact electrodes and a vibration switch mounted on the circuit board.

Preferably, the indicator lamp comprises at least one LED lamp.

The MCU is used for controlling the switching of the indicator lamp among a turn-off mode, a slow flashing mode and an SOS emergency rescue mode.

Two mounting holes are provided in the cover body, the top ends of the metal contact electrodes respectively stretch out of the mounting holes, a current loop is formed when the two contact electrodes meet water, the indicator lamp is turned on and controlled to flash when the MCU receives a current signal, and a waterproof ring is provided between each metal contact and each mounting hole.

The vibration switch is used for controlling the SOS emergency rescue mode of the indicator lamp, the vibration switch comprises a switch body, a conductive vibration spring mounted in the switch body and a trigger pin connected with the MCU, and the MCU controls to given out an SOS emergency rescue signal when the vibration spring contacts the trigger pin.

Preferably, a GPS positioning device is further mounted in the tube head, and the MCU enables a GPS positioning function when the vibration switch generates a trigger signal.

In one embodiment, the tube body further comprises an external second sealing box connected thereto, a gas detection device is mounted in the first sealing box, the gas detection device comprises a circuit board; a power source, an MCU, two contact electrodes with one end stretching out of the first sealing box, a two-color indicator lamp and/or an alarm mounted on the circuit board; and a probe stretching into the tube body through a rubber sleeve for detecting gas concentration, a waterproof sealing structure is provided between the rubber sleeve and the tube body and the first sealing box, and a waterproof ring is provided between the contact electrodes and the first sealing box.

In another embodiment, the tube body further comprises an external second sealing box connected thereto, the second sealing box is made of a transparent material, and a highly-identifiable object is placed inside.

Preferably, the power source is a lithium battery.

Compared with the prior art, the present invention has the following beneficial effects:

1. Since a light warning device is provided in the tube head and has a slow flashing warning function and an SOS international standard rescue signal function, the safety performance is improved and the life safety of athletes is effectively guaranteed.

2. Since it has a first sealing box and a gas detection device is mounted inside and is used for detecting the concentration of carbon dioxide or oxygen in the two tube bodies, the safety of divers is further guaranteed.

3. Since it has a detachable external second sealing box connected thereto, the second sealing box is made of a transparent material and a highly-identifiable object is placed inside, the searching by rescuers is facilitated.

### BRIEF DESCRIPTION OF THE DRAWINGS

The accompanying drawings illustrate one or more embodiments of the disclosure and together with the written description, serve to explain the principles of the disclosure. Wherever possible, the same reference numbers are used throughout the drawings to refer to the same or like elements of an embodiment, and wherein:

FIG. 1 illustrates an exploded structural schematic view of embodiment 1 of the present invention.

FIG. 2 illustrates a schematic diagram of a light warning device in the present invention.

FIG. 3 illustrates an exploded structural schematic view of another embodiment of the present invention.

FIG. 4 illustrates a schematic diagram of a gas detection module in the present invention.

FIG. 5 illustrates a schematic view of an external sealing box.

### DETAILED DESCRIPTION

The present invention will be further described below in conjunction with the accompanying drawings and embodiments.

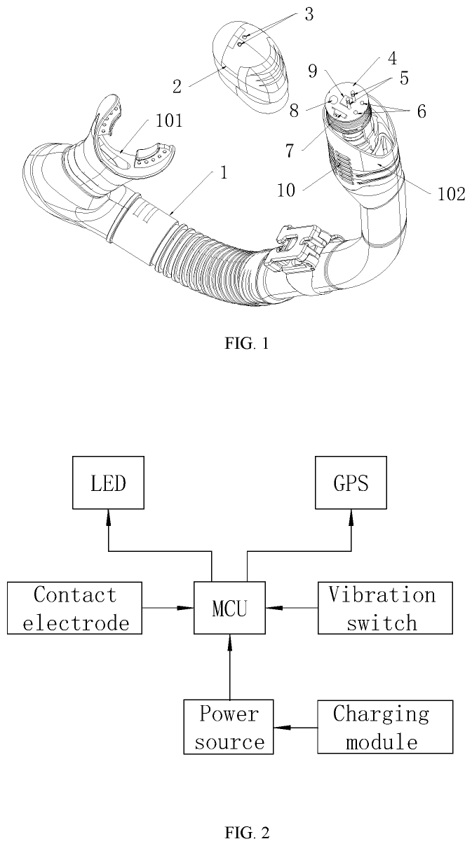

FIG. 1 illustrates one specific embodiment of the present invention. A diving breathing tube with a safety warning device provided in this embodiment comprises a tube body 1, one end of the tube body 1 is provided with a mouthpiece 101 and the other end is provided with a tube head 102. The tube head and the tube body are in clamping connection and a waterproof structure is provided. A cover body 2 is provided at the upper portion of the tube head, and the cover body is made of an insulating material with light transmission capacity.

The side wall of the tube head is provided with a drain outlet 10, a cavity communicated with the drain outlet is provided inside, and a floating ball is provided in the cavity. The upper portion of the cavity is provided with an air inlet and outlet communicated with the tube body. When the tube head 102 stretches out of the water surface, the floating ball sinks into the lower portion of the cavity under the effect of gravity, and the tube body is communicated with the outside through the air inlet and outlet and the drain outlet for air exchange. When the tube head 102 sinks into the water, the water flows into the cavity from the drain outlet 10, and the floating ball blocks the air inlet and outlet due to the increase of buoyancy of water, such that water is prevented from entering the tube body 1.

In the present invention, a light warning device is provided in the tube head 102. A water sealing structure is adopted between the tube body and the tube head 2 to ensure that the light warning device in the tube head will not be damaged due to short circuit caused by water inflow. Similarly, a waterproof seal is also adopted between the cover body 2 of the tube head and the tube head 102.

The light warning device comprises a circuit board 4 fixed in the tube head, and an indicator lamp 6, an MCU 9, a power source 8, metal contact electrodes 5 and a vibration switch 7 mounted on the circuit board.

The function of the indicator lamp 6 is light warning, one or more indicator lamp may be provided, and preferably the indicator lamp is an LED lamp. The indicator lamp 6 has three working modes: (1) turn-off mode, (2) slow flashing mode and (3) SOS emergency rescue mode.

The power source 8 is used for supplying power for the whole light warning device. The power source may be a 3V button battery, and the endurance is about 120 h. When no power is available, it can be used again by replacing with a new battery. A rechargeable lithium battery may also be used, and in this case there is no magnetic suction charging port in the tube head.

The contact electrodes 5 are switch control of the indicator lamp 6 in the slow flashing mode. Two mounting holes 3 are provided in the cover 2, and the top ends of the metal contact electrodes respectively stretch out of the two mounting holes in the cover 2. A sealing structure is provided between each contact electrode and each mounting hole to avoid short circuit caused by leakage of water. The two metal contacts are also required to be insulated from each other.

When the cover 2 is not in contact with water, the two contact electrodes 5 are not conducted; when the cover 2 is immersed in water or the two contact electrodes are touched simultaneously by a wet hand, the contact electrodes are in a conducted state through the conductivity of water and form a current loop; when the MCU 9 receives an electric signal, the indicator lamp 6 is controlled to be in the slow flashing mode, at this moment the indicator lamp will flash intermittently, i.e., emit light like twinkling, and the interval time is controlled by the MCU 9. The slow flashing mode can provide a warning to nearby people and improve the safety of divers.

The vibration switch 7 is used for controlling the indicator lamp 6 to give out an SOS international standard rescue signal. The working principle of the vibration switch is that a conductive vibration spring and a trigger pin are accurately placed in the body of the vibration switch 7 and fixed by adhesives, the spring and the trigger pin are not conducted when there is no vibration, the spring jitters and contacts the trigger pin such that it is energized to generates a trigger signal when the spring is beaten and vibrates.

Under emergency, the tube head is beaten according to preset beat times, the vibration switch 7 vibrates under beating and is conducted, and the MCU 9 controls the indicator lamp 6 to be in the SOS emergency rescue mode and given out an SOS international standard rescue signal. When an athlete is in danger, he can give out the SOS international standard rescue signal in time to remind rescuers to rescue in time, thus avoiding dangerous accidents and ensuring the safety of athletes.

The MCU 9 is electrically connected with the indicator lamp 6, the power source 8, the contact electrodes 5 and the vibration switch 7 respectively. According to the situation of conduction of the metal contact switch and the vibration switch, the light state of the indicator lamp 6 is controlled to realize switching among the turn-off mode, the slow flashing mode and the SOS emergency rescue mode.

A GPS positioning device may also be mounted in the tube head. In case of emergency, the MCU controls the GPS to work to facilitate the search personnel to know the position of the diver.

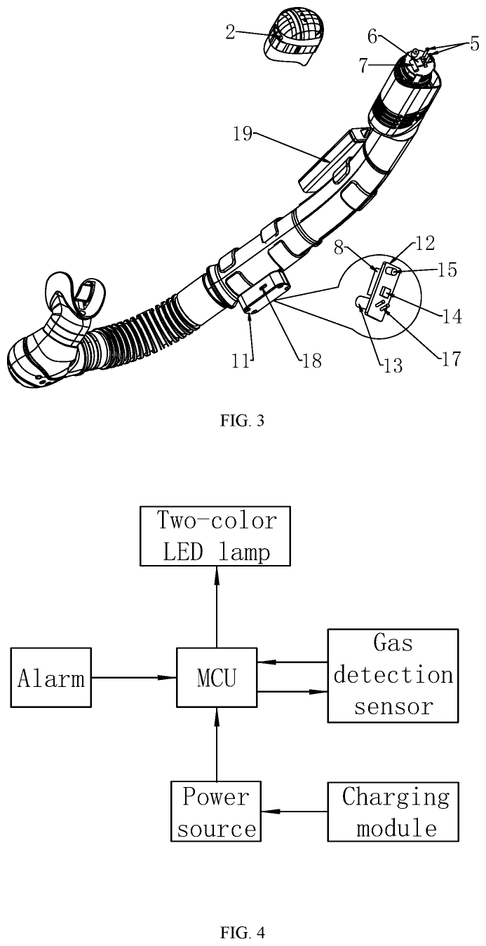

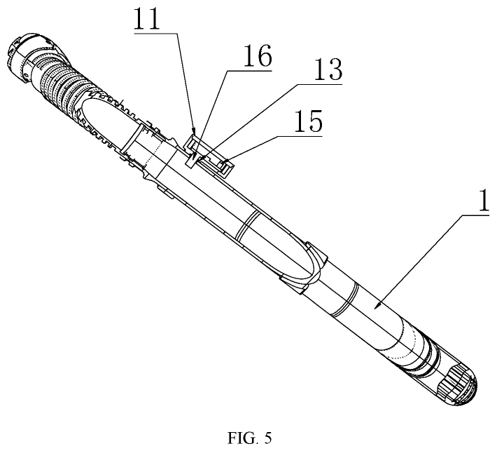

FIG. 3, FIG. 4 and FIG. 5 illustrate another embodiment of the present invention. In this embodiment, the diving breathing tube further comprises an external first sealing box 11 connected thereto, and a gas detection device is mounted in the first sealing box 11. The gas detection device comprises a circuit board 12, a power source 8, an MCU 14, contact electrodes 17, an indicator lamp 15 and/or an alarm, and a probe 16 which stretches into the tube body 1 through a rubber sleeve 13 and is used for detecting gas concentration. A waterproof sealing structure is provided between the rubber sleeve and the tube body and between the rubber sleeve and the first sealing box. The gas detection device is used for detecting the concentration of carbon dioxide or oxygen in the tube body. When the concentration exceeds the standard, the MCU triggers the alarm and/or the indicator lamp flashes to prompt the diver to pay attention.

As an alternative embodiment, the indicator lamp 15 may use a two-color lamp, a green lamp is on when oxygen is within the safe range, and a red lamp is on when oxygen is below the safe range.

The gas detection device may also comprise an alarm, which gives out an alarm signal when the oxygen exceeds the safe range to prompt the athlete to pay attention.

The power source 8 in the first sealing box may be a lithium battery or a rechargeable battery. In this case, a magnetic suction charging port 18 is provided in the first sealing box.

The tube body may further comprise an external second sealing box 19 connected thereto, the second sealing box is made of a transparent material, and a highly-identifiable object such as a red object or a luminous object is placed inside. The second sealing box may adopt a sealing cabin structure capable of being opened, which can be opened for placing a luminous or highly-identifiable object, so as to help to improve the identification rate among people.

The first sealing box and the second sealing box may be clamped on the tube body by adopting spring clips.

In the present invention, since a light warning device and a gas detection device are provided on the diving breathing tube, the safety capacity of the device is improved and the life safety of athletes is effectively guaranteed. In addition, in the present invention, the identification rate among divers is enhanced through the GPS and the second sealing box, which facilitates the searching by rescuers.

The above embodiments and drawings are only used for describing the concept of the present invention instead of limiting the present invention. The modifications made to the structure of the present invention, or the equivalent replacements made to some or all of its technical features, shall be included in the protection scope of the claims of the present invention.

What is claimed is:

1. A diving breathing tube with a safety warning device, comprising a tube body, one end of the tube body being provided with a mouthpiece, the other end being provided with a tube head, the tube head comprising a cover body and a cylinder body, wherein the inner portion of the tube head is provided with a light warning device, the cover body is made of an insulating material with light transmission capacity, and a waterproof sealing structure is adopted respectively between the cover body and the cylinder body of the tube head and between the tube head and the tube body.

2. The diving breathing tube with a safety warning device according to claim 1, wherein the light warning device comprises a circuit board, and an indicator lamp, an MCU, a power source, two contact electrodes and a vibration switch mounted on the circuit board.

3. The diving breathing tube with a safety warning device according to claim 2, wherein the indicator lamp comprises at least one LED lamp.

4. The diving breathing tube with a safety warning device according to claim 2, wherein the MCU is used for controlling the switching of the indicator lamp among a turn-off mode, a slow flashing mode and an SOS emergency rescue mode.

5. The diving breathing tube with a safety warning device according to claim 2, wherein two mounting holes are provided in the cover body, the top ends of the metal contact electrodes respectively stretch out of the mounting holes, a current loop is formed when the two contact electrodes meet water, the indicator lamp is turned on and controlled to flash when the MCU receives a current signal, and a waterproof ring is provided between each metal contact and each mounting hole.

6. The diving breathing tube with a safety warning device according to claim 2, wherein the vibration switch is used for controlling the SOS emergency rescue mode of the indicator lamp, the vibration switch comprises a switch body, a conductive vibration spring mounted in the switch body and a trigger pin connected with the MCU, and the MCU controls to give out an SOS emergency rescue signal when the vibration spring contacts the trigger pin.

7. The diving breathing tube with a safety warning device according to claim 1, wherein a GPS positioning device is further mounted in the tube head, and the MCU enables a GPS positioning function when the vibration switch generates a trigger signal.

8. The diving breathing tube with a safety warning device according to claim 1, wherein the tube body further comprises an external second sealing box connected thereto, a gas detection device is mounted in the first sealing box, the gas detection device comprises a circuit board; a power source, an MCU, two contact electrodes with one end stretching out of the first sealing box, a two-color indicator lamp and/or an alarm mounted on the circuit board; and a probe stretching into the tube body through a rubber sleeve for detecting gas concentration, a waterproof sealing structure is provided between the rubber sleeve and the tube body and the first sealing box, and a waterproof ring is provided between the contact electrodes and the first sealing box.

9. The diving breathing tube with a safety warning device according to claim 1, wherein the tube body further comprises an external second sealing box connected thereto, the second sealing box is made of a transparent material, and a highly-identifiable object is placed inside.

10. The diving breathing tube with a safety warning device according to claim 2, wherein the power source is a lithium battery.

11. The diving breathing tube with a safety warning device according to claim 8, wherein the power source is a lithium battery.
